(19) United States
(12) Patent Application Publication
(10) Pub. No.: US 2010/0314850 A1
(43) Pub. Date: Dec. 16, 2010

(54) Heavy Duty Vehicle with a Tread Including a Plurality of Parts

(75) Inventor: Francois Harle, Clermont-Ferrand (FR)

Correspondence Address: COHEN, PONTANI, LIEBERMAN & PAVANE LLP, 551 FIFTH AVENUE, SUITE 1210, NEW YORK, NY, 10176, US

(73) Assignees: SOCIETE DE TECHNOLOGIE MICHELIN, Clermont-Ferrand (FR); Michelin Recherche et Technique S.A., Granges-Paccot (CH)

(21) Appl. No.: 12/682,754

(22) PCT Filed: Oct. 8, 2008
(86) PCT No.: PCT/EP2008/063478

§ 371 Date: Aug. 24, 2010

(30) Foreign Application Priority Data
Oct. 10, 2007 (FR) 0707155

(51) Int. Cl. B60C 1/00; B62D 47/00

(52) U.S. Cl. 280/80.1; 152/209.5

(57) ABSTRACT

A vehicle, such as a public transport vehicle or a “civil engineering plant” vehicle, comprising at least two axle systems, at least one of them comprising at least two twin-mounted sets fitted with tires. Each of the treads of the tires fitted to two twin-mounted sets comprises at least on its exterior surface at least two circumferential parts made of polymer blends that have different physico-chemical properties, the distributions of the said polymer blends in the treads of each of the tires being symmetric with respect to a longitudinal plane passing through a point mid-way between the two twin-mounted sets.

The invention relates to a vehicle, such as a public transport vehicle or a “civil engineering plant” vehicle, comprising at least two axle systems, at least one of them comprising two twin-mounted sets fitted with tires.

Although not limited to this type of application, the invention will be described more specifically with reference to a vehicle of the “dumper” type with a mass in excess of 300 tonnes, fitted with tires of a diameter in excess of three metres fifty with an axial width in excess of 37 inches.

Such vehicles, generally intended to carry heavy loads, comprise a steered front axle system comprising two steered wheels and a rear axle system, usually rigid, comprising four driven wheels distributed in pairs on each side.

An axle system is defined as a set of components connecting the fixed structure of the vehicle to the ground.

The circumferential direction of the tire, or the longitudinal direction, is the direction corresponding to the periphery of the tire and defined by the direction in which the tire runs.

The transverse or axial direction of the tire is parallel to the axis of rotation of the tire.

The radial direction is a direction that intersects the axis of rotation of the tire and is perpendicular thereto.

The axis of rotation of the tire is the axis about which it revolves in normal use.

A radial or meridian plane is a plane containing the axis of rotation of the tire.

A circumferential plane is a plane perpendicular to the axis of rotation of the tire.

The circumferential median plane, or equatorial plane, is a plane perpendicular to the axis of rotation of the tire and which splits the tire into two halves.

In the case of vehicles, notably those intended for use in mines or quarries for transporting loads, lack of ease of access and efficiency requirements are leading the manufacturers of these vehicles towards increasing their load-carrying capability. It therefore follows that the vehicles are becoming increasingly large and therefore also increasingly heavy and able to transport an increasingly heavy load. The current mass of such vehicles may be as high as several hundred tonnes and the same is true of the load being transported; the overall mass may be as much as 600 tonnes.

At the present time, as previously stated, vehicles of this type, such as the “dumpers” used in mines, have a driven rear axle system on which there are mounted four wheels, twinned in pairs, in order to meet these requirements.

What is more, the dimensions of these wheels and therefore the dimensions of the tires and particularly the stiffness of the bottom zones entail that the said wheels be made in several parts in order to allow the tire to be fitted onto a rim. The fitting and removal of these tires which occur in the event of replacement or servicing entail lengthy and painstaking handling operations. The number of tightening components that have to be handled during such operations may be in excess of 200, and there are very high tightening torques associated with these components. The time taken to perform these operations is therefore long and as such detrimental to the sought-after productivity in the running of these mines.

Present-day demands are tending evermore towards an increase in the load-carrying capability of these vehicles and so the various parameters listed herein above have led to a widening of the tires so as to increase the volume of air therein. This is because it is practically impossible to increase the diameter of tire that has been attained nowadays, which is of the order of 4 metres, particularly for reasons associated with the transport of the said tires. Specifically, the dimensions of these tires will be limited for transport purposes, notably by the width of the roads and by bridge clearance heights. It is also practically impossible to reduce the diameter of the rim because this rim is notably used to house the system that transmits the driving torque and the braking systems.

In the course of their research, the inventors have been able to demonstrate that these “widened” tires do indeed allow an increase in the load transported but have various disadvantages. Indeed, tests have shown that the wear resistance of these tires diminishes, notably as far as tires twinned on the rear axle system are concerned, notably on account of torque phenomena induced between the tires and which occur notably under cornering. More frequent tire changes lead to a reduction in the efficiency of these vehicles. Present-day vehicles are fitted with differentials between the wheels of one and the same axle system which are positioned on each side of an axis of symmetry of the said axle system in order to lessen these phenomena.

Furthermore, they have demonstrated that, under certain running conditions with a certain load, the handling of the vehicle, particularly on curved paths, becomes vastly inferior. Specifically, when the tires of the front axle system are turned through a steering angle, notably when the vehicle is laden and when cornering at relatively small radii of curvature, it sometimes happens that the vehicle continues along a substantially straight path. Indeed it would seem that, under certain loading and running conditions, a vehicle such as this, fitted with four tires as described herein above on the rear axle system, is very difficult if not to say impossible to handle in a curved path, the vehicle not responding to the steering angle imposed by the tires of the front axle system. This may be particularly noticeable when driving on slippery surfaces such as mud, snow or ice, or even when cornering at small radii of curvature, it being necessary to apply a greater steering angle in order to make the vehicle corner. These conditions may also lead to cleavage and destruction of the tires of the front axle system and therefore once again lead to more frequent tire changes.

Elsewhere, patent application WO 00/71365 has described a technique that simplifies the fitting of the tires, these being mounted directly on the hub which thus acts as a rim. Independent rings then act as rim seats and are held in place by locking rings which are secured to the hub notably by complementary profiles.

The inventors thus set themselves the task of improving the properties of the tires of these heavy duty vehicles in terms of wear by comparison with those of present-day tires, notably with a view to improving the efficiency of the vehicles and also improving the handling of these vehicles whatever the conditions in which they are used and driven.

This object has been achieved according to the invention by a vehicle, such as a public transport vehicle or a “civil engineering plant” vehicle, comprising at least two axle systems, at least one of them comprising at least two twin-mounted sets fitted with tires, each of the treads of the tires fitted to two twin-mounted sets comprising at least on its exterior surface at least two axially contiguous circumferential parts made of polymer blends that have different physico-chemical properties, and the distributions of the said polymer blends in the treads of each of the tires being symmetric with respect to a longitudinal plane passing through a point mid-way between the two twin-mounted sets.

A mounted set in the sense of the invention consists, for example, of a wheel and a tire. It may be any other system allowing a tire to be mounted on a vehicle, such as, for example, the tire mounting technique described in application WO 00/71365.

The inventors have been able to demonstrate that the twinning of the conventional tires fitted to the rear axle system leads to induced stresses in the tires which, on the one hand, accentuates tire wear that is uneven in the axial direction of the tires when the vehicle is following a curved path and, on the other hand, creates stresses which make the vehicle more difficult to handle on such paths.

The use of twinned tires as defined in the invention leads to lower and more uniform tire wear, particularly in bends. Specifically, the design of the vehicle according to the invention will make it possible to reduce the longitudinal stresses due to the torques induced between the tires and which occur notably when the vehicle follows the line of a curve. The more uniform tread wear thus obtained means that the tire tread form can be preserved and tire functionality thus optimized in terms of driving and load bearing. This more uniform wear also means that satisfactory torque transfer can be maintained over time, particularly in curved paths, and thus makes it possible to avoid or at the very least limit the lockup situations mentioned previously and therefore maintain satisfactory vehicle handling.

In consequence, the twinned tires according to the invention lead to better operation of the vehicle and to less frequent tire changes and therefore better productivity.

According to the invention, the tires fitted to two twinned wheels are therefore different. On one and the same axle system comprising two pairs of twinned wheels, the tires will be able to be identical in pairs. The tire fitted to the axially inboard wheel of a first pair of twinned wheels will be identical to the tire fitted to the axially outboard wheel of the other pair of twinned wheels. In this way it will be possible to improve tire endurance performance by swapping two identical tires over after a given period of running. This swapping, which is common practice for this type of application, makes it possible to modify the stresses borne by the tire, this tire thus swapping from an axially inboard position on a twinned wheel set to an axially outboard position.

According to a first advantageous embodiment of the invention, which corresponds in particular to the driving of vehicles of the dumper type on grounds of the stony type, the axially outboard circumferential parts of the treads of the tires fitted to two twin-mounted sets made of polymer blends have rigidity properties superior to the rest of the tread surface. In other words, the polymer blends of the axially outboard circumferential parts of the treads have rigidity properties that are able to tolerate slippage without exhibiting excessive wear.

Advantageously too, according to this first embodiment of the invention, the ratio of the modulus of elasticity of the axially outboard circumferential parts of the treads of the tires fitted to two twin-mounted sets to that of the axially inboard circumferential parts of the treads of the said tires is greater than or equal to 70%.

The “modulus of elasticity” of a rubber blend means a secant tensile modulus at 10% deformation and ambient temperature.

As far as the rubber compounds are concerned, the modulus measurements are made in tension in accordance with AFNOR-NFT-46002 September 1988: the nominal secant modulus (or apparent stress) is measured in second elongation (i.e. after an accommodation cycle) in MPa at 10% elongation (normal temperature and moisture conditions in accordance with AFNOR-NFT-40101 December 1979).

The axially inboard and axially outboard positions are considered relative to a twinned set of tires.

According to a second advantageous embodiment of the invention, corresponding notably to the running of vehicles of the fork-lift truck type on surfaces of the concrete or tarmac type likely to be subjected to very small turning circles, the axially outboard circumferential parts of the treads of the tires fitted to two twin-mounted sets made of polymer blends have rigidity properties inferior to the rest of the tread. In other words, the polymer blends of the axially outboard circumferential parts of the treads have rigidity properties able to tolerate deformation without exhibiting excessive wear. Such tires therefore advantageously have tread patterns suited to the nature of the polymer blends of the tread; these tread patterns are, for example, siped on the axially outboard circumferential parts of the treads notably with a view to further increasing the deformation without excessive wear.

Advantageously too, according to this second embodiment of the invention, the ratio of the modulus of elasticity of the axially inboard circumferential parts of the treads of the tires fitted to two twin-mounted sets to that of the axially outboard circumferential parts of the treads of the said tires is greater than or equal to 35%.

One alternative form of embodiment of the invention has it that the treads of each of the tires fitted to two twin-mounted sets have, at least on their exterior surfaces, a gradient of variation of the physico-chemical properties in the axial direction. According to this alternative form of embodiment of the invention, the physico-chemical properties of each of the treads vary continuously in the axial direction.

According to a first embodiment of the invention, in any circumferential plane of the treads of each of the tires fitted to two twin-mounted sets, the physico-chemical properties are identical in the longitudinal and radial directions. According to this first embodiment of the invention, the tread is made up of at least two circumferential parts, each being uniform throughout its thickness, that is to say in the radial direction. The tread of the tire will therefore maintain, at its surface, a distribution of its physico-chemical properties that remains constant irrespective of the wear of the said tread.

According to a second embodiment of the invention, in any circumferential plane of the treads of each of the tires fitted to two twin-mounted sets, the physico-chemical properties are identical in the longitudinal direction, and exhibit at least one variation in the radial direction. According to this second embodiment of the invention, each of the circumferential parts has at least two radially superposed polymer blends. Such an embodiment may possibly allow, once the radially exterior first layers have worn away, the positions of the two tires on the two twinned wheels to be swapped over by choosing, for example, radially superposed layers with switched properties in each of the two circumferential parts that constitute the two shoulders of each of the tires.

According to certain configurations of vehicles, the rear axle system of the vehicle comprises at least four twin-mounted sets mounted in pairs, each of the tires fitted to the mounted sets being tires according to the invention.

In other vehicle configurations, the front axle system of the vehicle comprises at least four twin-mounted sets mounted in pairs, each of the tires fitted to the mounted sets being tires according to the invention.

Other types of vehicles may also comprise several axle systems, each comprising twin-mounted sets, each of the tires fitted to the mounted sets being tires according to the invention.

The invention also relates to vehicles comprising several axle systems each equipped with twin-mounted sets, just one or several axle systems comprising tires fitted to the mounted sets being in accordance with the invention.

The invention also advantageously makes provision for combining the vehicle as defined hereinabove with a wheelless mounting on the front axle system, the tires being fitted onto the hub provided for this purpose via mounting first rings that form the seats for the beads of the tires and locking second rings that ensure the correct positioning of the said first rings and therefore of the tires. This form of mounting has already been described in the aforementioned patent application WO 00/71365. According to this embodiment, the invention requires the provision on the hub of recesses to accept the locking rings, each tire requiring the fitting of two of these rings. Mounting the tires on a vehicle in this way allows a further improvement in the productivity of the vehicle, the tires becoming simpler and quicker to replace.

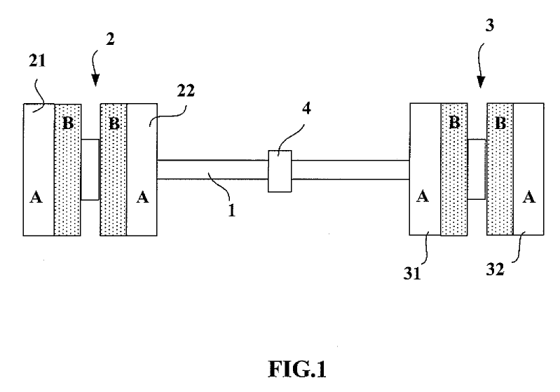

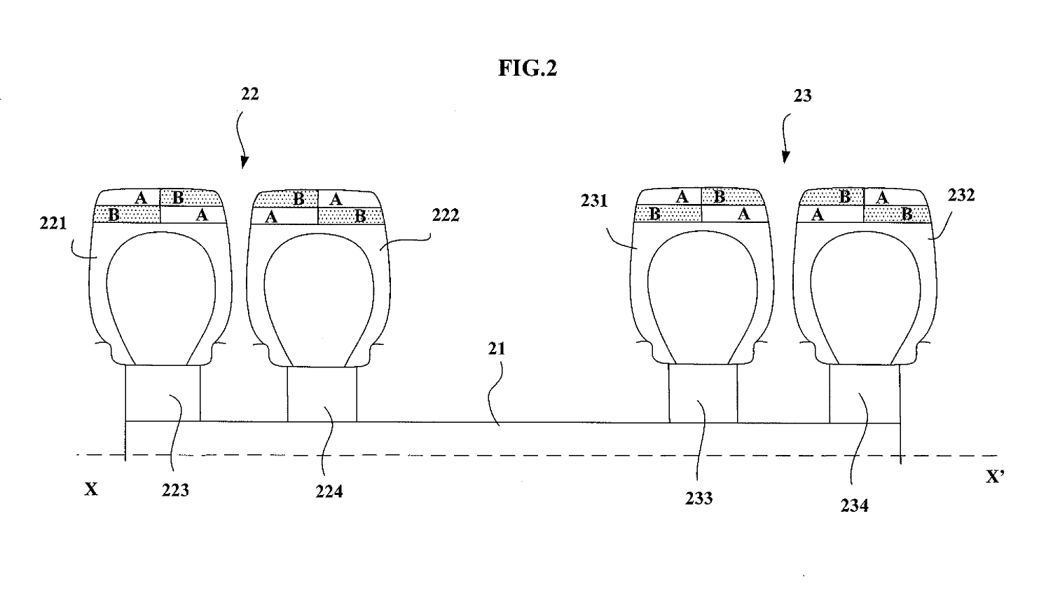

Other details and advantageous features of the invention will become apparent hereinafter from the description of some examples of embodiments of the invention given with reference to FIGS. 1 and 2 which depict:

FIG. 1, a schematic depiction of an axle system of a vehicle according to the invention,

FIG. 2, a cross-sectional diagram of an axle system of a vehicle according to a second embodiment of the invention.

In order to make them easier to understand, the figures have not been drawn to scale. FIG. 2 depicts only half of the mounted sets which continue symmetrically with respect to the axis XX′ which represents a meridian plane of the mounted sets.

FIG. 1 schematically depicts an axle system 1 of a vehicle comprising two pairs 2, 3 of twin-mounted sets respectively comprising tires 21, 22 and 31, 32. At the middle of the axle system 1 there is usually a differential 4 which distributes the drive across each side of the axle system 1.

An axle system 1 such as this is taken, for example, from a vehicle of the caterpillar 797 dumper type with a total laden weight of the order of 630 tonnes.

The tires fitted to this vehicle are large-sized tires in which the aspect ratio H/S is equal to 0.80, H being the height of the tire on the rim and S the maximum axial width of the tire when the latter is mounted on its service rim and inflated to its recommended pressure. These are tires of the 59/80R63 size.

According to the invention, each of the tires 21, 22, 31, 32 has treads comprising two circumferential parts made of polymer blends with different physico-chemical properties. The nature of the blends is indicated on the treads by the letters “A” and “B”. The blends “A” are polymer blends with a modulus of elasticity of 7.7 N/mm² and the blends “B” are polymer blends with a modulus of elasticity of 4.3 N/mm². The blends A also have a coefficient of friction less than 0.3 and the blends B have a coefficient of friction in excess of 0.6.

When running, the distribution and choice of these polymer blends makes it possible, particularly under cornering, to reduce the stresses induced between the tires. Specifically, blend “A”, which is more rigid and situated at the axially inboard shoulder of the axially inboard tire 22 and at the axially outboard shoulder of the axially outboard tire 23, makes it possible to reduce the respective driving and braking effects of each of these shoulders as a result of greater slippage. It follows that wear on these shoulders, unlike in conventional tires, is not accentuated under cornering by comparison with the other parts of the tire treads.

The diagram of FIG. 1 also shows that the tires 21 and 31 can be swapped over with one another. The same is true of the tires 22 and 32. This swapping of the tires makes it possible, by positioning the tire at different locations on the vehicle, to obtain more even fatigue of these components, these components being stressed differently at each of the different locations.

Tests have been conducted with two identical vehicles running along the same route. The vehicles had four tires mounted on the rear axle system twinned in pairs. The first vehicle had tires according to the invention whereas the second vehicle was fitted with conventional tires. Only the treads differed between the various tires. The runs performed demonstrated that the vehicle according to the invention exhibited uniform tire wear allowing substantially cylindrical shapes to be maintained whereas the wear of the tires on the second vehicle was uneven, wear being more pronounced on the axially outboard edges of the tires when considering a twinned set.

It was also found that, when tire wear was visible, the vehicle according to the invention handled better, particularly in its ability to follow curved paths with relatively small radii of curvature.

FIG. 2 schematically illustrates an axle system 21 of a vehicle comprising two pairs 22, 23 of twin-mounted sets comprising tires 221, 222 and 231, 232 and wheels 223, 224 and 233, 234, respectively.

As in the case of FIG. 1, the polymer blends present at the surface of the tread vary in the axial direction. Thus, each of the tires 221, 222, 231, 232 has treads with, at the surface, two circumferential parts made of polymer blends with different physico-chemical properties. As in the case of FIG. 1, the nature of the blends is indicated on the treads by the letters “A” and “B”. In their initial state, the polymer blends present at the surface of the treads are identical to those of FIG. 1. However, after a given amount of tread wear, FIG. 2 shows that the wearing-away of a blend “A” will reveal a blend “B” and the wearing-away of a blend “B” will reveal a blend “A”. The properties at the surface of the tread of these tires are therefore reversed by comparison with their initial state. In order to return to the configuration according to the invention it is then necessary to swap over, for example, the tires 221 and 222 with, for example, the tires 231 and 232. As explained previously with reference to FIG. 1, this operation is beneficial because it will in fact make it possible to use a tire according to the invention on all the locations of a vehicle axle system and therefore even out stresses and therefore fatigue experienced by the tires and more specifically by the components thereof optimally.

The invention should not be taken as being restricted to the description of these examples. A tread of a tire fitted to a vehicle according to the invention may, for example, comprise more than two circumferential parts made of polymer blends with different physico-chemical properties. The tread may consist of polymer blends with a gradual surface variation in the physico-chemical properties.

The invention has essentially been described with reference to civil engineering plant vehicles of the dumper type, but must also be understood to apply to any vehicles that have an axle system comprising twin-mounted sets in which the tires are of a width that leads to uneven wear or even to any vehicles that have an axle system comprising twin-mounted sets the use of which requires them to corner at small bend radii.

The invention also applies to vehicles comprising one or more axle systems equipped with twin-mounted sets, the characteristics of the treads of the tires according to the invention being found in the tires of one or several axle systems, whether these be driven, steered or load-bearing or combine two or three of these qualities.

1. A vehicle such as a public transport vehicle or a “civil engineering plant” vehicle, comprising at least two axle systems, at least one of the axle systems comprising at least two twin-mounted sets fitted with tires, wherein each of the tires fitted to the two twin-mounted sets having a tread that comprises at least on its exterior surface at least two circumferential parts made of polymer blends that have different physico-chemical properties, and wherein the distributions of said polymer blends in the treads of each of the tires are symmetric with respect to a longitudinal plane passing through a point mid-way between the two twin-mounted sets.

2. The vehicle according to claim 1, wherein the axially outboard circumferential parts of the treads of the tires fitted to the two twin-mounted sets made of polymer blends have rigidity properties superior to the rest of the tread surface.

3. The vehicle according to claim 1, wherein the ratio of the modulus of elasticity of the axially outboard circumferential parts of the treads of the tires fitted to two twin-mounted sets made of polymer blends to that of the axially inboard circumferential parts of the treads of the tires is greater than or equal to 70%.

4. The vehicle according to claim 1, wherein the axially outboard circumferential parts of the treads of the tires fitted to the two twin-mounted sets made of polymer blends have rigidity properties inferior to the rest of the tread surface.

5. The vehicle according to claim 1, wherein the ratio of the modulus of elasticity of the axially inboard circumferential parts of the treads of the tires fitted to the two twin-mounted sets made of polymer blends to that of the axially outboard circumferential parts of the treads of the tires is greater than or equal to 35%.

6. The vehicle according to claim 1, wherein the treads of each of the tires fitted to the two twin-mounted sets have, at least on their exterior surfaces, a gradient of variation of the physico-chemical properties in the axial direction.

7. The tire according to claim 1, wherein, in any circumferential plane of the treads of each of the tires fitted to the two twin-mounted sets, the physico-chemical properties are identical in the longitudinal and radial directions.

8. The vehicle according to claim 1, wherein, in any circumferential plane of the treads of each of the tires fitted to the two twin-mounted sets, the physico-chemical properties are identical in the longitudinal direction, and exhibit at least one variation in the radial direction.

9. The vehicle according to claim 1, wherein the rear axle system of the vehicle comprises at least four twin-mounted sets mounted in pairs.

10. The vehicle according to claim 1, wherein the front axle system of the vehicle comprises at least four twin-mounted sets mounted in pairs.

11. The vehicle according to claim 1, wherein the tires are mounted on a hub via mounting first rings that form the seats for the beads of the tires and locking second rings that ensure the correct positioning of the said first rings which are secured to the hub notably as a result of profiles that complement housings made in the hub.

12. A tire for use on a vehicle, such as a public transport vehicle or a “civil engineering plant” vehicle, comprising at least two axle systems, at least one of the axle systems comprising at least two twin-mounted sets fitted with the tires, wherein each of the tires fitted to the two twin-mounted sets comprises a tread having at least on its exterior surface at least two circumferential parts made of polymer blends that have different physico-chemical properties, and wherein the distributions of said polymer blends in the treads of each of the tires are symmetric with respect to a longitudinal plane passing through a point mid-way between the two twin-mounted sets.

13. The tire according to claim 12, wherein axially outboard circumferential parts of the treads of the tires fitted to the two twin-mounted sets made of polymer blends have rigidity properties superior to the rest of the tread surface.

14. The tire according to claim 12, wherein the ratio of the modulus of elasticity of the axially outboard circumferential parts of the treads of the tires fitted to the two twin-mounted sets made of polymer blends to that of the axially inboard circumferential parts of the treads of the tires is greater than or equal to 70%.

15. The tire according to claim 12, wherein axially outboard circumferential parts of the treads of the tires fitted to the two twin-mounted sets made of polymer blends have rigidity properties inferior to the rest of the tread surface.

16. The tire according to claim 12, wherein the ratio of the modulus of elasticity of axially inboard circumferential parts of the treads of the tires fitted to the two twin-mounted sets made of polymer blends to that of the axially outboard circumferential parts of the treads of the tires is greater than or equal to 35%.

17. The tire according to claim 12, wherein the treads of each of the tires fitted to the two twin-mounted sets have, at least on their exterior surfaces, a gradient of variation of the physico-chemical properties in the axial direction.

18. The tire according to claim 12, wherein, in any circumferential plane of the treads of each of the tires fitted to the two twin-mounted sets, the physico-chemical properties are identical in the longitudinal and radial directions.

19. The tire according to claim 12, wherein, in any circumferential plane of the treads of each of the tires fitted to the two twin-mounted sets, the physico-chemical properties are identical in the longitudinal direction, and exhibit at least one variation in the radial direction.
